(19) United States
(12) Patent Application Publication
(10) Pub. No.: US 2014/0246416 A1
(43) Pub. Date: Sep. 4, 2014

(54) ELECTRICALLY HEATED GARMENT

(71) Applicant: Black & Decker Inc., (US)

(72) Inventor: Daniel J. White, Baltimore, MD (US)

(73) Assignee: Black & Decker Inc., Newark, DE (US)

(21) Appl. No.: 13/783,803

(22) Filed: Mar. 4, 2013

(51) Int. Cl. A41D 1/02; H05B 3/34

(52) U.S. Cl. CPC A41D 1/02; H05B 3/342
USPC 219/211

(57) ABSTRACT

An article of clothing includes a garment body and a heater disposed within to the garment body. A battery holder defines a cavity. A rechargeable battery pack is configured for use with at least one of a power tool and a sensing device. The rechargeable battery pack is slidably received within the cavity and detachably coupled to the battery holder by a latching arrangement. A controller selectively provides power from the rechargeable battery pack to the heater. A user input member for selecting a mode of the controller is coupled to the garment body. An electroluminescent element is disposed on the garment body. The electroluminescent element is electrically connected to the power tool battery pack.

### FIELD OF THE INVENTION

The present invention relates to garments, and in particular, to an electrically heated jacket for providing heat to a user wearing the jacket.

### BACKGROUND

Garments, especially outwear such as jackets and parkas, may be insulated to protect a user from the cold. Insulated jackets rely on the user's own body heat to keep the user warm. If the insulation is too thin, the user may be cold. If the insulation is too thick, the user may overheat.

Such garments are typically used outdoors, possibly in low visibility conditions. It may be desirable to increase the visibility of the user.

### BRIEF DESCRIPTION OF THE DRAWINGS

FIG. 1 illustrates a jacket according to one embodiment of the invention, where FIGS. 1A-1B are a front view and a cross-sectional view along line B-B in FIG. 1A, respectively.

FIG. 2 is a rear view of the jacket of FIG. 1.

FIG. 3 is a detailed view of a rear compartment of the jacket of

FIG. 2, and taken along line 3-3 of FIG. 2.

FIG. 4 is a perspective view of a battery holder according to one embodiment of the invention, where FIGS. 4A-4B are top and bottom perspective views, respectively.

FIG. 5 is a perspective view of a battery pack for use with the battery holder of FIG. 4.

FIG. 6 is an exploded view of the battery pack of FIG. 5.

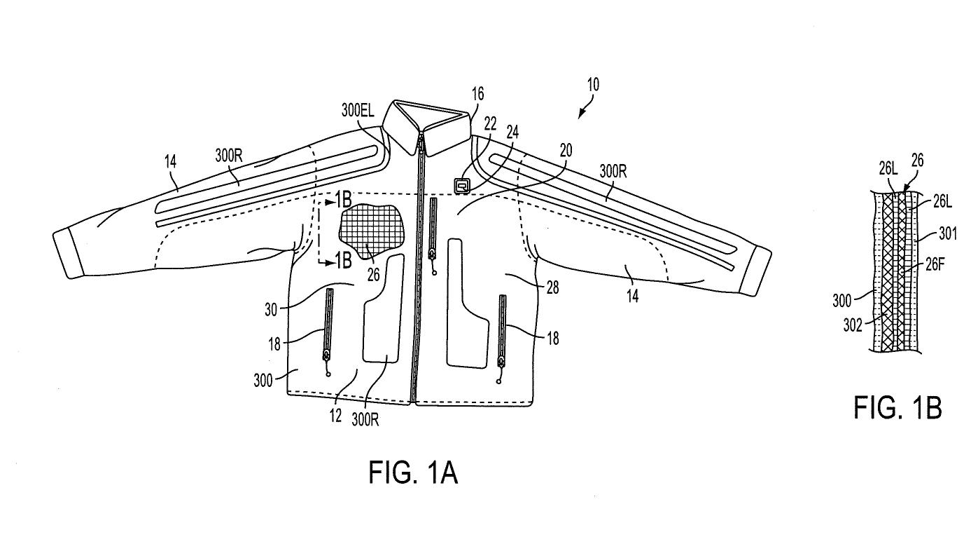

FIG. 7 is an electrical block diagram for the jacket of FIG. 1.

FIG. 8 illustrates a jacket/vest combination according to one embodiment of the invention, where FIGS. 8A-8B are front and rear views, respectively.

FIG. 9 is a perspective view of tools and devices usable with the battery pack of FIG. 5.

### DESCRIPTION

FIG. 1 illustrates a heated jacket 10 according to one embodiment of the invention. The jacket 10 may be constructed in various sizes to fit a variety of users. The jacket 10 includes typical jacket features such as a torso body 12, arms 14, a collar 16, and front pockets 18. A front surface 20 of the jacket 10 includes a control input. In the illustrated embodiment, the control input is a button 22 that may be actuated by user. As explained in greater detail below, the button 22 includes a display portion 24 (or display 178) to indicate a status of the heated jacket 10. For further information on jacket 10, persons skilled in the art are referred to US Patent Publication No. 2001/0108538, which is fully incorporated herein by reference.

Preferably the heated jacket 10 has an outer layer 300, which may be made of a water-proof or water-resistant fiber, such as GORE-TEX®, nylon or polyester. Outer layer 300 may also have patches 300R of light reflective fabric. These patches may have an aluminum or fluorescent orange color with embedded glass beads to reflect light. Outer layer 300 may also have a light source, such as LEDs or electroluminescent elements 300EL, which glow/light up when power is applied thereto.

Similarly, the heated jacket 10 has an inner layer 301 that could be made of synthetic materials, such as polyester and/or microfiber-based fabrics, and/or wool, silk, cotton, etc. In between the outer and inner layers 300, 301, jacket 10 could have a mid-layer 302 to provide additional insulation. Mid-layer 302 could be made of wool, fleece, down, synthetic fiberfill and/or cotton.

As illustrated in cutaway portions of FIGS. 1 and 2, the jacket 10 includes a heater array 26. The heater array 26 is disposed in both a left portion 28 and a right portion 30 of the torso body 12. In some embodiments, the heater array 26 may extend into the arms 14 and/or collar 16. In other embodiments the jacket 10 may include a first heater array and second heater array arranged as an upper module and a lower module, respectively.

The heating array 26 may include resistive heating coils 26F formed of carbon fibers, high density carbon fibers, or other heating devices. Preferably heating coils 26F are sandwiched between two fabric sheets 26L. At least one of the fabric sheets 26L may have a thermal bonding adhesive film or coating. With such construction, the heating coil 26F can be fixed in place relative to the fabric sheets 26L by pressing the layers together and applying heat.

In the illustrated embodiment, the heater array 26 is controlled via the button 22 shown in FIG. 1. In other embodiments, multiple heater arrays may be controlled individually via a single control input or multiple control inputs. The heated jacket 10 is capable of maintaining a temperature of up to 110 degrees Fahrenheit, although in further embodiments lower or greater temperatures are possible depending upon the heat source.

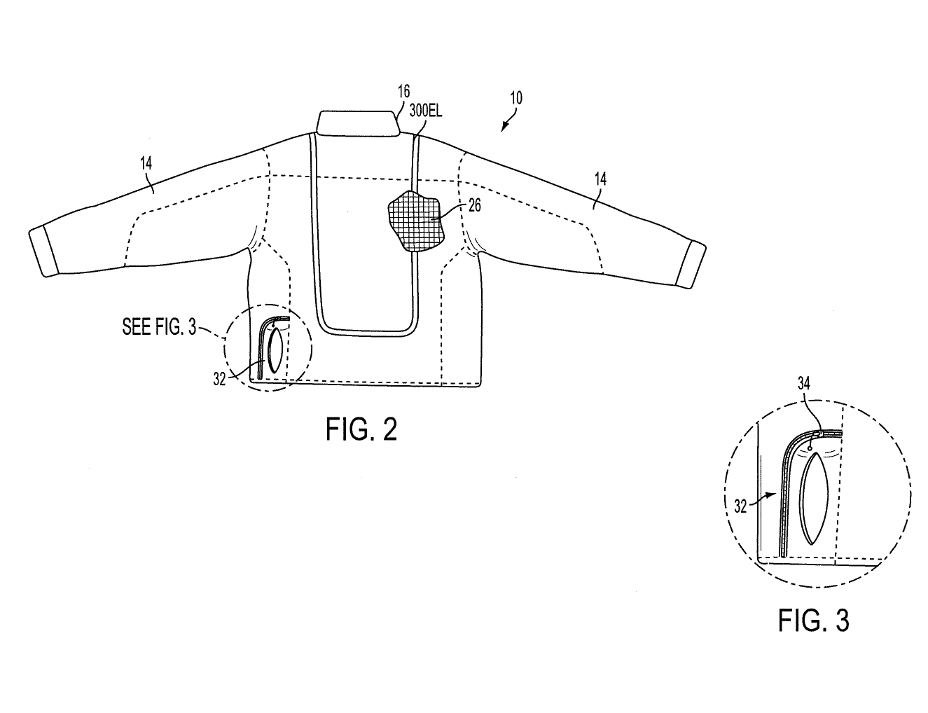

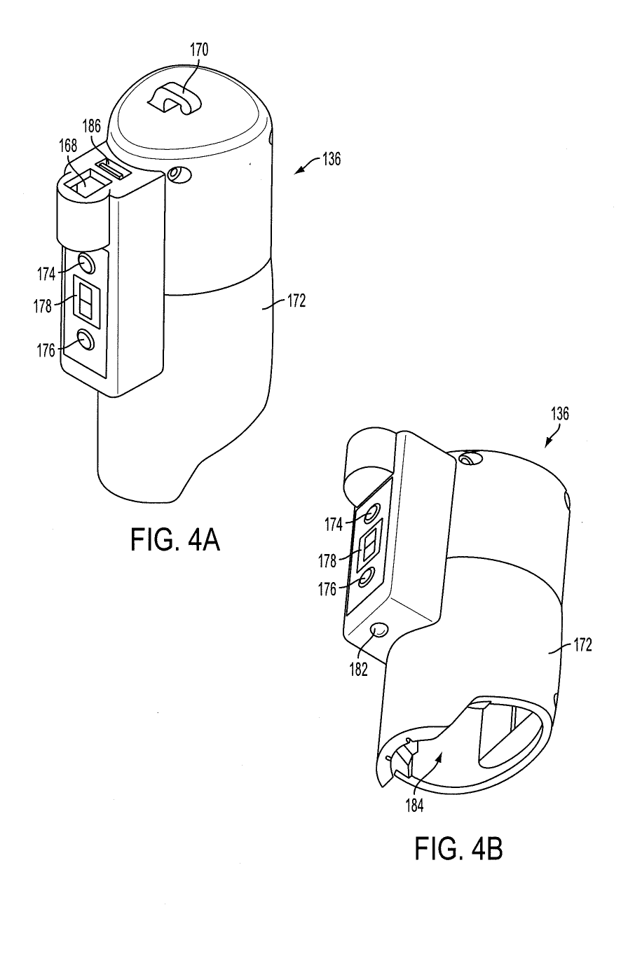

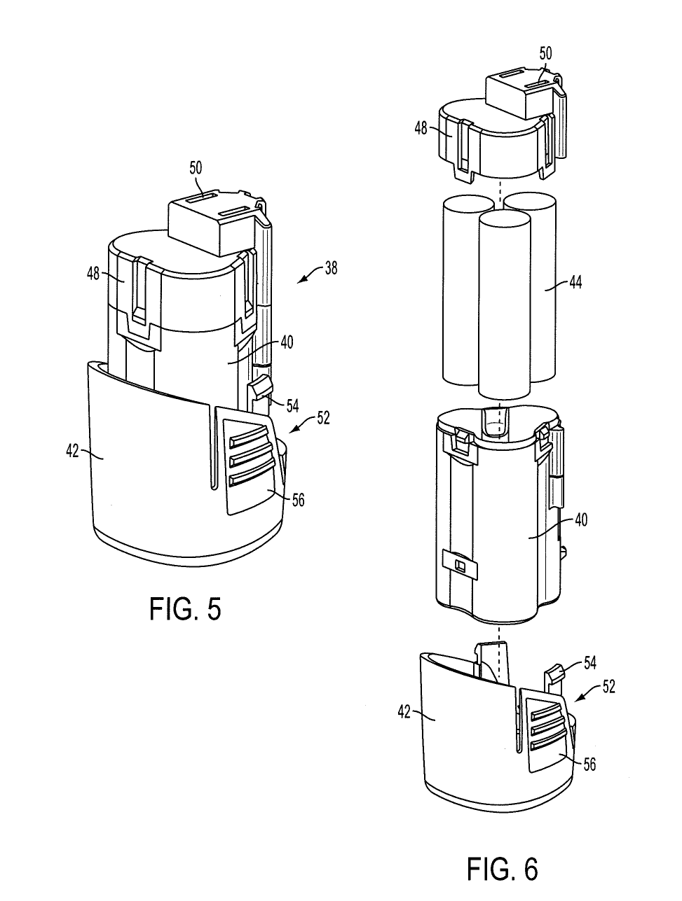

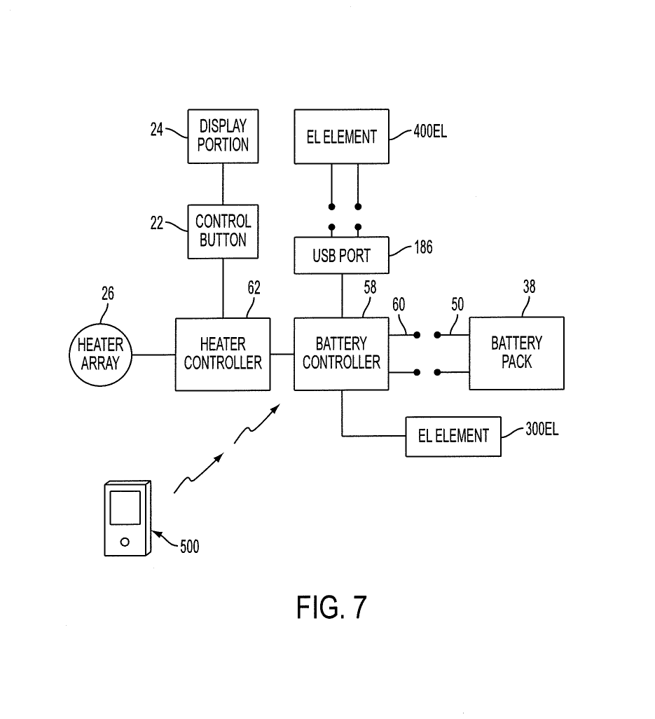

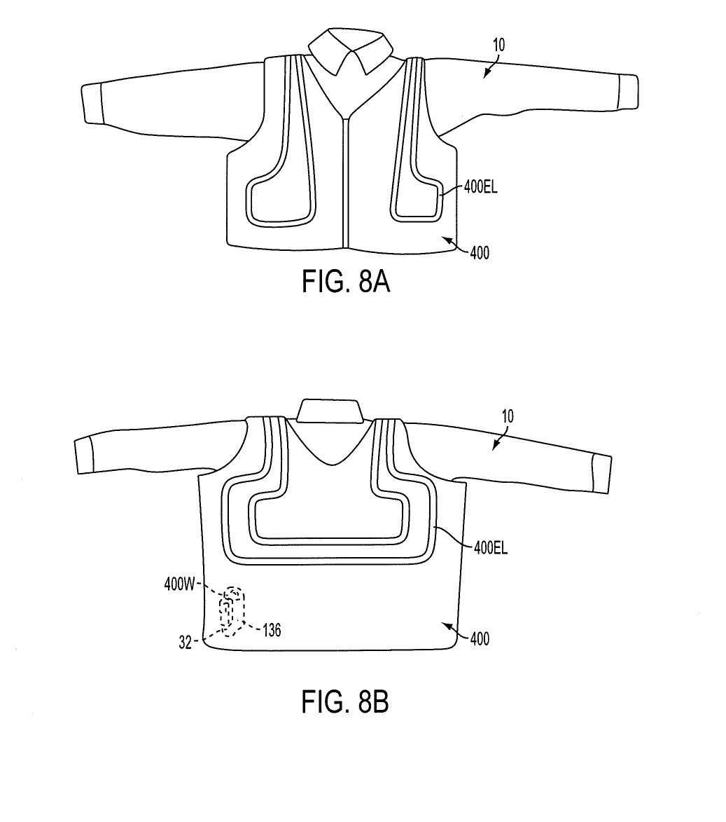

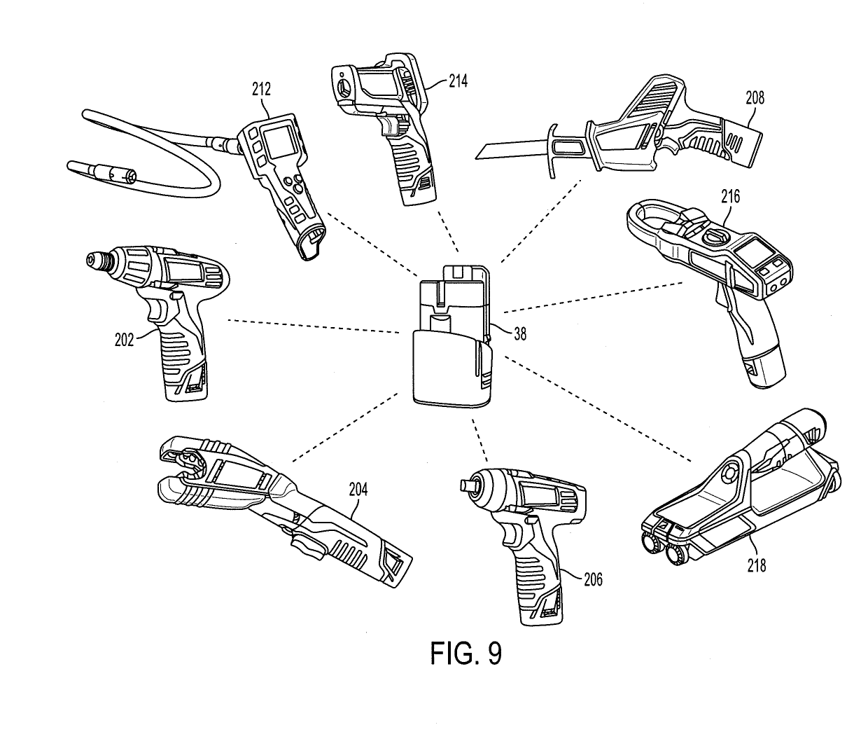

As illustrated in FIG. 2, the heated jacket 10 may include a compartment 32 located on a lower portion of the back torso body. The compartment 32 houses an electrical component, such as a battery pack 38and battery holder 136. As illustrated in FIG. 3, the compartment 32 includes a zipper 34, providing selective access by a user to the Compartment 32 in order to access the battery pack and other electrical components. Preferably, compartment 32 will be accessible from both the interior of the jacket 10 as well as the exterior of jacket 10.

FIG. 4 illustrates one example of a battery holder 136. The battery holder 136 is configured to receive a battery pack 38, such as the battery pack illustrated in FIG. 5.

The battery holder 136 preferably includes an aperture 168 for receiving an end of a cord (not shown), the cord being connected to the one or more heating coils 26F and including a male connector terminal. A female connector (not shown) is positioned within the battery holder 136 adjacent the aperture 168 to receive the male connector and form an electrical connection between the heating coils 26F and the battery pack 38. The battery holder 136 also includes a hook 170 for securing the cord disposed between the connector and the jacket 110.

The battery holder 136 may also include a housing portion 172 for electrical components, including a circuit board (not shown). The housing portion 172 includes a first button 174, a second button 176 and a display 178. The first button 174 and the second button 176 are capable of communicating with the electrical components. In the illustrated embodiment, the first button 174 is pressed by a user to increase the temperature of the heating coils 26F, and the second button 176 is pressed by a user for lowering the temperature of the heating coils 26F. Display 178 preferably displays a number representative of a heating level indicative of the temperature of the heating coils 26F.

The battery holder 136 may also include a power indicator 182, such as a light emitting diode (LED) that displays to the user when lit that the battery pack 38 is connected, the heating coils 26F are on, or the like. A portion of the battery holder 136 defines a battery cavity 184 for receiving the battery pack 38. Persons skilled in the art will recognize that battery cavity 184 need not receive completely and completely enclose battery pack 38. Instead battery cavity 184 may just receive a portion of battery pack 38.

In other embodiments, the battery holder 136 includes an on/off switch (such as the control button 22 discussed above), a fuel gauge that displays the amount of battery power remaining, and a user interface including heat zone controls to individually control the heating coils 26F if multiple heating coils are employed.

Battery holder 136 may also have an Universal Serial Bus (USB) port 186 for providing power to any USB-powered device.

Referring to FIG. 5, the battery pack 38 is a lithium-based, rechargeable battery pack. The battery pack 38 is removably and interchangeably connected to the battery holder 136 to provide power to the jacket 10 during operation and to facilitate recharging of the battery pack 38 when not in use. In some embodiments, the battery pack 38 may be used with other types of cordless, battery-powered tools or devices. FIG. 13, discussed below, illustrates exemplary tools and devices with which the battery pack 38 may be used. The battery pack 38 also may be used with other power tools or sensing devices not specifically discussed herein.

As illustrated in FIGS. 5 and 6, the battery pack 38 includes a casing 40, an outer housing 42 coupled to the casing 40, and a plurality of battery cells 44 positioned within the casing 40. The casing 40 is shaped and sized to fit within a cavity 186 of the battery holder 136 illustrated in FIG. 4, or alternatively, in a power tool or non-motorized sensing device to connect the battery pack 38 to the tool or device. The casing 40 includes an end cap 48 to substantially enclose the battery cells 44 within the casing 40.

The illustrated end cap 48 may include two power terminals 50 configured to mate with corresponding power terminals 60 (FIG. 7) extending within the cavity 184 of the battery holder 136. In other embodiments, the end cap 48 may also include sense or communication terminals that are configured to mate with corresponding terminals within the battery holder 136 or a tool. The outer housing 42 includes a latching arrangement 52 for positively engaging the battery pack 38 with the battery holder 136. The latching arrangement 52 includes latching tabs 54 and resilient actuating portions 56. The latching tabs 54 are configured to engage corresponding recesses within the cavity 184 of the battery holder 136. The resilient actuating portions 56 are coupled to the latching tabs 54 and are configured for a user to selectively disengage the latching tabs 54 from the battery holder 136.

As shown in FIG. 6, the battery pack 38 includes three battery cells 44 positioned within the casing 40 and electrically coupled to the terminals 50. The battery cells provide operational power (e.g., DC power) to the jacket 10 or other device. In the illustrated embodiment, the battery cells 44 are arranged in series, and each battery cell has a nominal voltage of approximately four-volts (4.0V), such that the battery pack 38 has a nominal voltage of approximately twelve-volts (12V). The cells 44 also have a capacity rating of approximately 1.4 Ah. In other embodiments, the battery pack 38 may include more or fewer battery cells 44, and the cells 44 can be arranged in series, parallel, or a serial and parallel combination. For example, the battery pack 38 can include a total of six battery cells in a parallel arrangement of two sets of three series-connected cells. The series-parallel combination of battery cells creates a battery pack having a nominal voltage of approximately 12V and a capacity rating of approximately 2.8 Ah. In other embodiments, the battery cells 44 may have different nominal voltages, such as, for example, 3.6V, 3.8V, 4.2V, etc., and/or may have different capacity ratings, such as, for example, 1.2 Ah, 1.3 Ah, 2.0 Ah, 2.4 Ah, 2.6 Ah, 3.0 Ah, etc. In other embodiments, the battery pack 38 can have a different nominal voltage, such as, for example, 10.8V, 14.4V, 18V, etc.

In the illustrated embodiment, the battery cells 44 are lithium-ion battery cells having a chemistry of, for example, lithium-cobalt (Li—Co), lithium-manganese (Li—Mn), or Li—Mn spinel. In other embodiments, the battery cells 44 may have other suitable lithium or lithium-based chemistries.

The heated jacket 10 includes control circuitry for the heater array 26 and battery pack 38. FIG. 7 is a block diagram of the heated jacket 10. A battery controller 58 receives electricity from the battery pack 38 via battery terminals 60 (disposed within the battery holder 136). The battery controller 58 may be configured to monitor a state of charge of the battery pack 38 and, if necessary, shutdown the heater array 26.

A heater controller 62 receives inputs from the control button 22 (such as buttons 174, 176) and selectively powers the heater array 26 depending upon the selected thermal output. The display portion 24 is selectively illuminated based upon the selected thermal output setting. The heater controller 62 may be configured to monitor a plurality of conditions of the jacket 10 including, but not limited to, an amount of current drawn by the heater array 26. The controllers 58, 62 are, for example, microprocessors, microcontrollers, or the like, and are configured to communicate with one another.

In the illustrated embodiment, the battery controller 58 provides information to the heater controller 62 related to a battery pack temperature or voltage level. The heater controller 62 and the battery controller 58 also include low voltage monitors and state-of-charge monitors. The monitors are used to determine whether the battery pack 38 is experiencing a low voltage condition, which may prevent proper operation of the heater array 26, or if the battery pack 38 is in a state-of-charge that makes the battery pack 38 susceptible to being damaged. If such a low voltage condition or state-of-charge exists, the heater array 26 is shut down or the battery pack 38 is otherwise prevented from further discharging current to prevent the battery pack from becoming further depleted.

Battery controller 58 may also provide convert the power coming in from battery pack 38 to a desired power output. For example, battery controller 58 may take the power output of battery pack 38 (at 14.4V) and convert it into a power output for USB port 186 compliant with the USB specifications, i.e., 4-5V and 150 mA-900 mA. Battery controller 58 may also drive other electronic components, such as electroluminescent element 300EL.

Battery controller 58 may also receive signals from a computing device 500 such as a smartphone or computer via a wired connection (such as the USB port 186) or a wireless connection (such as a BlueTooth wireless connection). Computing device 500 can send control signals to the battery controller 58 to control the state (on/off/other) of the electroluminescent elements 300EL, 400EL, the heater, array 26, etc.

The heated jacket 10 illustrated in FIGS. 1 and 2 may be operated as follows. To turn on the heated jacket 10, a user presses and holds the control button 22 for a first period (e.g., three seconds). When first turned on, the heater controller 62 causes the heated jacket 10 to enter pre-heat mode. The heated jacket 10 remains in a pre-heat mode for a period (e.g., five minutes) and then the heater controller 62 switches the heater array 26 to a medium thermal output setting. The user may adjust the thermal output setting by actuating the control button 22. Each press of the control button 22 will cycle the heater controller 62 through one of a sequence of thermal output settings (e.g., low, medium, high). In order to turn off the heated jacket 10 (or de-energize the heater array 26), the user presses and holds the control button 22 for a third period (e.g., three seconds).

As mentioned previously, the control button 22 includes an illuminated display portion 24 to indicate a status of the heaters. The display portion may be, for example, one or more LEDs. In the pre-heat mode, the display portion 24 flashes red. At a low thermal output setting, the display portion 24 glows blue. At a medium thermal output setting, the display portion 24 glows white. At a high thermal output setting, the display portion glows red. Other embodiments may use various other colors or light patterns to indicate thermal output settings. Still other embodiments may indicate a state of charge of the battery pack 38.

Various modifications of the control method or sequence are possible. For example, in other embodiments, the user may select a desired temperature rather than a thermal output setting.

FIG. 8 illustrates a jacket/vest combination, where a user wears a heated jacket 10 as described above, and a vest 400 layered on jacket 10. Vest 400 is preferably made of high visibility plain weave, open mesh fabric, comprised of 24% high tenacity polyester yarn and 76% flexible foamed PVC, and is preferably pigmented with daylight fluorescent colors such as red, orange or yellow. Vest 400 may also have a light source, such as LEDs or electroluminescent elements 400EL.

Preferably the electroluminescent elements 400EL are connected to a connecting wire 400W, which plugs into the USB port 186 of battery holder 136. Preferably, the wire 400W will extend from vest 400 at a location that is adjacent to compartment 32.

FIG. 9 illustrates exemplary power tools and sensing devices with which the battery pack 38 may be usable. The battery pack 38 may be usable with power tools such as a drill 202, a pipe cutter 204, an impact driver 206, and a reciprocating saw 208. The battery pack 38 may also be usable with non-motorized sensing devices such as a visual inspection camera 212, an infrared sensor 214 (such as a thermometer or thermal imaging camera), a clamp-type multimeter 216, and a wall scanner 218 (such as a “stud finder”).

The description of the invention is merely exemplary in nature and, thus, variations that do not depart from the gist of the invention are intended to be within the scope of the invention. Such variations are not to be regarded as a departure from the scope of the invention.

What is claimed is:

1. An article of clothing comprising:
a garment body having first and second layers;
a heater coupled to the garment body, disposed between the first and second layers;
a battery holder defining a cavity;
a rechargeable power tool battery pack configured for use with at least one of a power tool and a sensing device, the rechargeable power tool battery pack slidably received within the cavity and detachably coupled to the battery holder by a latching arrangement;
a controller selectively providing power from the rechargeable battery pack to the heater;
an electroluminescent element disposed on the garment body, the electroluminescent element being electrically connected to the battery pack; and
a user input member coupled to the garment body, the user input member for selecting a mode of the controller.

2. The article of clothing of claim 1, wherein the user input member is also configured for selecting a thermal output of the heater.

3. The article of clothing of claim 1, further comprising a display indicating a thermal output setting.

4. The article of clothing of claim 3, wherein the display is illuminated.

5. The article of clothing of claim 1, wherein the user input member includes a display indicating a thermal output setting.

6. The article of clothing of claim 5, wherein the display comprises a plurality of LED lights.

7. The article of clothing of claim 5, wherein the display further indicates a state of charge of the rechargeable battery pack.

8. The article of clothing of claim 1, wherein the user input member comprises a button.

9. The article of clothing of claim 1, wherein the user input member is coupled to an external surface of the garment.

10. The article of clothing of claim 1, wherein the garment body includes a pocket for receiving the battery holder and rechargeable battery pack.

11. The article of clothing of claim 10, wherein the garment body includes a third layer separable from the first and second layers.

12. The article of clothing of claim 11, wherein the electroluminescent element is disposed on the third layer.

13. The article of clothing of claim 12, wherein the electroluminescent element has a connector that is substantially aligned with the pocket.

14. The article of clothing of claim 1, wherein the garment body includes reflective material disposed on the second layer.

15. The article of clothing of claim 1, wherein the battery holder has a USB port.

16. An article of clothing comprising:
a garment body;
a heater disposed within the garment body;
a battery holder defining a cavity, the battery holder disposed within the garment body and electrically coupled to the heater;
a rechargeable power tool battery pack slidably received within the cavity and detachably coupled to the battery holder by a latching arrangement;
a user input member coupled to the garment body;
an electroluminescent element disposed on the garment body, the electroluminescent element being electrically connected to the power tool battery pack; and
a controller for selectively providing power from the power tool battery pack to the heater in response to control signals from the user input member, the controller causing the heater to enter a pre-heat mode in response to a first signal from the user input member, maintaining the heater in the pre-heat mode for a first time period, automatically switching the heater to a first thermal setting at the end of the first time period, and selectively switching the heater to a second thermal setting in response to a second signal from the user input member.

17. The article of clothing of claim 16, wherein the rechargeable battery pack is configured for use with at least one of a power tool and a sensing device.

18. The article of clothing of claim 16, further comprising a display indicating a thermal output setting.

19. The article of clothing of claim 16, wherein the user input member includes a display indicating a thermal output setting.

20. The article of clothing of claim 16, wherein the user input member is coupled to an external surface of the garment.
